(19) United States
(12) Patent Application Publication
(10) Pub. No.: US 2026/0273938 A1
(43) Pub. Date: Sep. 17, 2026

(54) Liquid Ejecting Head And Printing Apparatus

(71) Applicant: SEIKO EPSON CORPORATION, Tokyo (JP)

(72) Inventors: Takanori AIMONO, Shiojiri (JP); Takahiro KATAKURA, Okaya (JP); Mitsuki EBISAWA, Shiojiri (JP)

(21) Appl. No.: 19/567,763

(22) Filed: Mar. 16, 2026

(30) Foreign Application Priority Data
Mar. 17, 2025 (JP) 2025-042381

(51) Int. Cl. B41J 2/14

(52) U.S. Cl. CPC B41J 2/1433; B41J 2/14233; B41J 2002/14475; B41J 2202/03; B41J 2202/11

(57) ABSTRACT

A liquid ejecting head includes a nozzle that ejects a liquid, and the nozzle includes an opening that includes a plurality of ejection openings in communication with each other and ejects the liquid, and an inclined portion provided on a side surface of the nozzle and inclined such that an inner diameter of the nozzle decreases toward the opening.

The present application is based on, and claims priority from JP Application Serial Number 2025-042381, filed Mar. 17, 2025, the disclosure of which is hereby incorporated by reference herein in its entirety.

### BACKGROUND

### 1. Technical Field

The present disclosure relates to a liquid ejecting head and a printing apparatus.

### 2. Related Art

JP-A-2023-105419 describes a nozzle whose cross-sectional outer shape has two circular arcs.

In recent years, from the viewpoint of productivity, an increase in printing speed has been demanded. However, in the case of using a nozzle having a cross-sectional shape as in JP-A-2023-105419, when the ejection speed of liquid droplets increases, the movement of a meniscus formed at the respective ejection positions formed of two circular arcs increases, and bubbles are easily pulled into the nozzle. In particular, bubbles are likely to enter a space between ejection portions formed of two circular arcs. For this reason, when the nozzle described in JP-A-2023-105419 is used, there is a possibility that the ejection of liquid droplets from the nozzle becomes unstable.

### SUMMARY

In order to solve the above problems, a liquid ejecting head according to a preferred aspect of the present disclosure includes a nozzle that ejects a liquid, and the nozzle includes an opening that includes a plurality of ejection openings in communication with each other and ejects the liquid, and an inclined portion provided on a side surface of the nozzle and inclined such that an inner diameter of the nozzle decreases toward the opening.

A printing apparatus according to a preferred aspect of the present disclosure includes the liquid ejecting head according to the above-described aspect, and a controller that controls an operation of the liquid ejecting head.

### BRIEF DESCRIPTION OF THE DRAWINGS

FIG. 1 is a schematic diagram illustrating a configuration example of a printing apparatus according to a first embodiment.

FIG. 2 is an exploded perspective view of a liquid ejecting head according to the first embodiment.

FIG. 3 is a sectional view taken along line III-III in FIG. 2.

FIG. 4 is a sectional view of a nozzle in the first embodiment.

FIG. 5 is a plan view of the nozzle in the first embodiment.

FIG. 6 is an explanatory graph of an example of a drive signal.

FIGS. 7A to 7E are explanatory diagrams of a meniscus when the drive signal illustrated in FIG. 6 is used.

FIGS. 8A to 8E are explanatory diagrams of a meniscus of a nozzle with no inclined portion.

FIG. 9 is a sectional view of a nozzle in a second embodiment.

FIG. 10 is a plan view of a nozzle in a third embodiment.

FIG. 11 is a plan view of an opening of a nozzle of a first modification.

FIG. 12 is a plan view of an opening of a nozzle of a second modification.

FIG. 13 is a plan view of an opening of a nozzle of a third modification.

FIG. 14 is a plan view of an opening of a nozzle of a fourth modification.

FIG. 15 is a plan view of an opening of a nozzle of a fifth modification.

FIG. 16 is a plan view of an opening of a nozzle of a sixth modification.

FIG. 17 is a plan view of an opening of a nozzle of a seventh modification.

FIG. 18 is a plan view of an opening of a nozzle of an eighth modification.

FIG. 19 is a plan view of an opening of a nozzle of a ninth modification.

FIG. 20 is a plan view of a nozzle of a tenth modification.

FIG. 21 is a plan view of a nozzle of an eleventh modification.

### DESCRIPTION OF EMBODIMENTS

Hereinafter, preferred embodiments according to the present disclosure will be described with reference to the accompanying drawings. In the drawings, the dimensions and scales of each portion are different from actual ones as appropriate, and some portions are schematically illustrated for ease of understanding. In addition, the scope of the present disclosure is not limited to the embodiments unless it is stated in the following description that the present disclosure is particularly limited.

For convenience, an X-axis, a Y-axis, and a Z-axis intersecting with each other will be used as appropriate in the following description. In the following, one direction along the X-axis is an X1 direction, and a direction opposite to the X1 direction is an X2 direction. Similarly, directions opposite to each other along the Y-axis are a Y1 direction and a Y2 direction. In the following, viewing in a Z1 direction or a Z2 direction may be referred to as “plan view”.

Here, typically, the Z-axis is a vertical axis, and the Z2 direction corresponds to a downward direction in a vertical direction. However, the Z-axis does not necessarily have to be the vertical axis. The X-axis, the Y-axis, and the Z-axis are typically orthogonal to each other, but are not limited thereto, and need only intersect with each other at an angle within a range of from, for example, 80° to 100°.

### 1. First Embodiment

### 1-1: Overall Configuration of Printing Apparatus

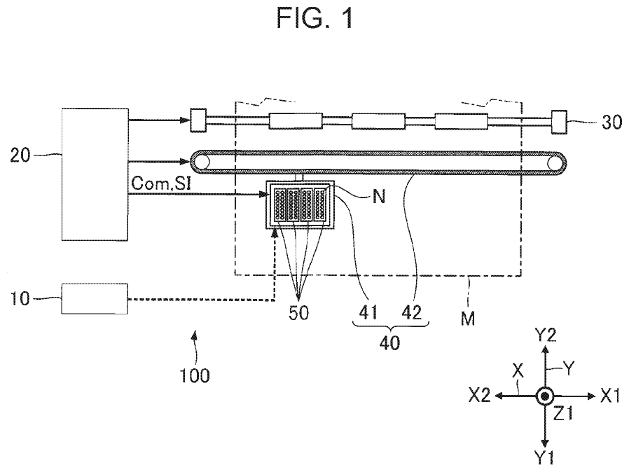

FIG. 1 is a schematic diagram illustrating a configuration example of a printing apparatus 100 according to a first embodiment. The printing apparatus 100 is an ink jet type printing apparatus that ejects ink, which is an example of a “liquid”, toward a recording medium M as liquid droplets. For example, the recording medium M is printing paper. The recording medium M is not limited to printing paper, and may be, for example, a printing target of any material such as a resin film or fabric.

As illustrated in FIG. 1, the printing apparatus 100 includes a liquid container 10, a control module 20, a transport mechanism 30, a moving mechanism 40, and a plurality of liquid ejecting heads 50. The control module 20 is an example of a “controller”.

The liquid container 10 stores inks. Specific aspects of the liquid container 10 include, for example, a cartridge attachable to and detachable from the printing apparatus 100, a bag-shaped ink pack formed of a flexible film, and an ink tank that can be refilled with an ink. The type of ink stored in the liquid container 10 is appropriately selected.

The control module 20 controls the operation of each element of the printing apparatus 100. For example, the control module 20 includes a processing circuit such as a central processing unit (CPU) or a field programmable gate array (FPGA) and a storage circuit such as a semiconductor memory. Here, the control module 20 outputs a drive signal Com for driving each liquid ejecting head 50 and a control signal SI for controlling the driving of the liquid ejecting head 50. The control module 20 controls the operation of the liquid ejecting head 50 by the drive signal Com and the control signal SI.

The transport mechanism 30 transports the recording medium M along the Y-axis under the control of the control module 20.

The moving mechanism 40 reciprocates the liquid ejecting heads 50 along the X-axis under the control of the control module 20. The moving mechanism 40 includes a carriage 41 that accommodates the liquid ejecting heads 50 and an endless transport belt 42 to which the carriage 41 is fixed. In addition to the liquid ejecting heads 50, the above-described liquid container 10 may be mounted on the carriage 41.

Each of the plurality of liquid ejecting heads 50 ejects the ink supplied from the liquid container 10 from each of a plurality of nozzles N on the recording medium M under the control of the control module 20. The ejection is performed in parallel with the transport of the recording medium M by the transport mechanism 30 and the reciprocating movement of the liquid ejecting head 50 by the moving mechanism 40, thereby forming an image by the ink on a surface of the recording medium M.

In the example illustrated in FIG. 1, the number of liquid ejecting heads 50 is four. The number of liquid ejecting heads 50 is not limited to the example illustrated in FIG. 1, and may be any number, may be one, or may be three or less or five or more. In addition, the disposition of the plurality of liquid ejecting heads 50 is not limited to the example illustrated in FIG. 1, and may be any disposition.

In the printing apparatus 100 described above, as will be described later, bubbles remaining in the nozzles N of each liquid ejecting head 50 can be suppressed, as a result which a decrease in printing quality can be suppressed even when the printing speed is increased.

### 1-2: Liquid Ejecting Head

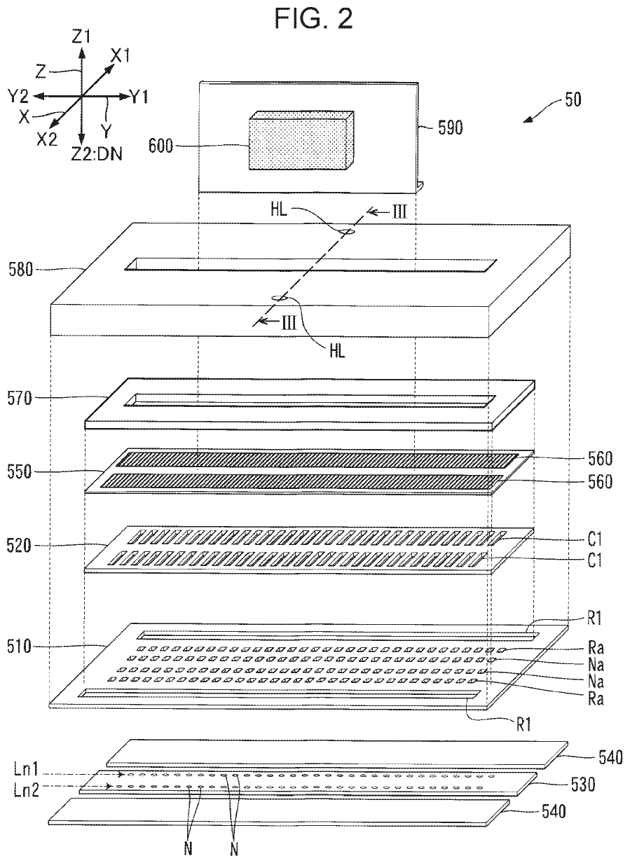

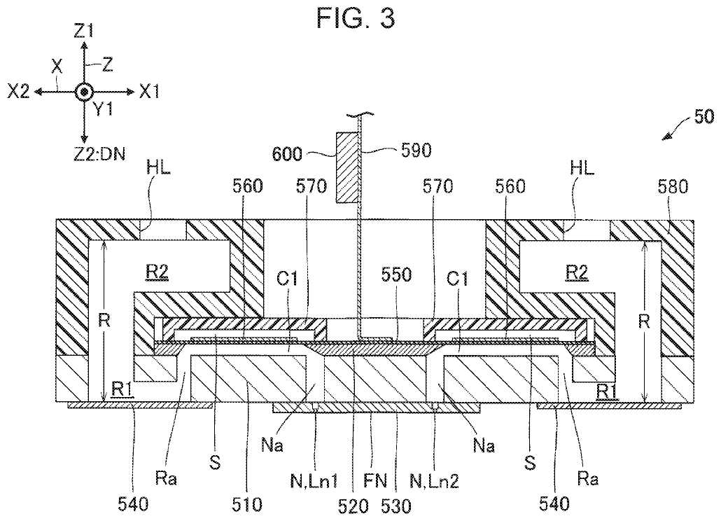

FIG. 2 is an exploded perspective view of the liquid ejecting head 50 according to the first embodiment. FIG. 3 is a sectional view taken along line III-III in FIG. 2. Hereinafter, an example of the configuration of the liquid ejecting head 50 will be described.

As illustrated in FIGS. 2 and 3, the liquid ejecting head 50 includes the plurality of nozzles N for ejecting an ink in an ejecting direction DN. In the present embodiment, the ejecting direction DN is the Z2 direction.

The plurality of nozzles N included in the liquid ejecting head 50 is divided into a first nozzle row Ln1 and a second nozzle row Ln2 arranged at an interval from each other in the direction along the X-axis. Each of the first nozzle row Ln1 and the second nozzle row Ln2 is a set of the plurality of nozzles N linearly arranged in the direction along the Y-axis.

The liquid ejecting head 50 has a substantially symmetrical configuration in the direction along the X-axis. However, positions of the plurality of nozzles N of the first nozzle row Ln1 and the plurality of nozzles N of the second nozzle row Ln2 in the direction along the Y-axis may coincide with or may be different from each other. FIGS. 2 and 3 illustrate a configuration in which the positions of the plurality of nozzles N of the first nozzle row Ln1 and the plurality of nozzles N of the second nozzle row Ln2 coincide with each other in the direction along the Y-axis.

As illustrated in FIGS. 2 and 3, the liquid ejecting head 50 includes a communication substrate 510, a pressure chamber substrate 520, a nozzle plate 530, vibration absorbers 540, a vibration plate 550, a plurality of piezoelectric elements 560, a protective substrate 570, a case 580, and a wiring substrate 590. The piezoelectric elements 560 are an example of an “actuator”.

The communication substrate 510 and the pressure chamber substrate 520 are stacked in this order in the Z1 direction and form a flow path for supplying the ink to the plurality of nozzles N. The vibration plate 550, the plurality of piezoelectric elements 560, the protective substrate 570, the case 580, the wiring substrate 590, and a drive circuit 600 are installed in a region located further in the Z1 direction than is a stacked body formed by the communication substrate 510 and the pressure chamber substrate 520. On the other hand, the nozzle plate 530 and the vibration absorbers 540 are installed in a region located further in the Z2 direction than is the stacked body. Each element of the liquid ejecting head 50 is approximately a plate-shaped member elongated in the Y direction, and is bonded to each other with, for example, an adhesive. Hereinafter, each element of the liquid ejecting head 50 will be described in order.

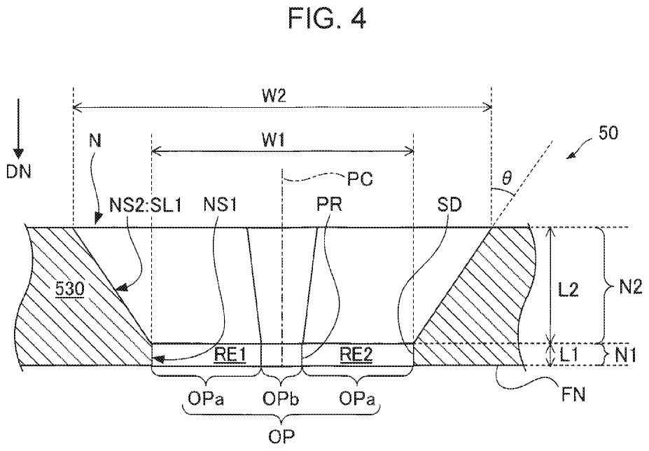

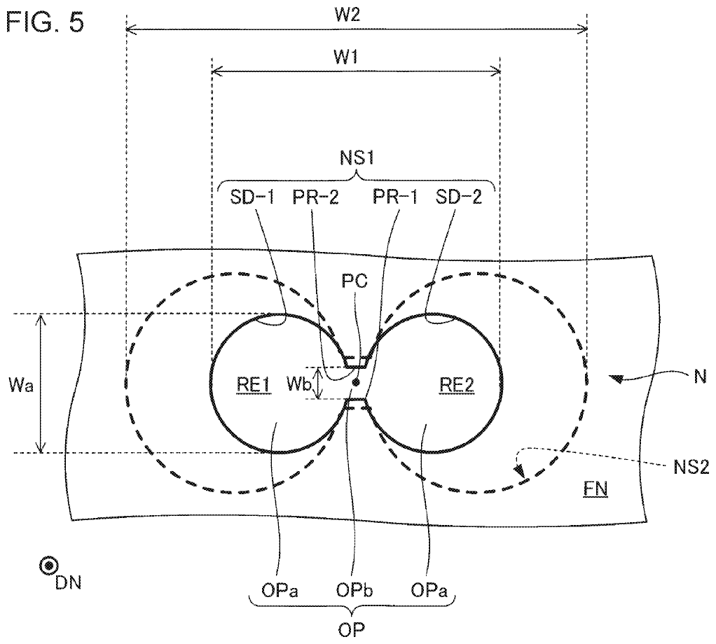

The nozzle plate 530 is a plate-shaped member provided with the plurality of nozzles N of each of the first nozzle row In1 and the second nozzle row Ln2. Each of the plurality of nozzles N is a through-hole through which the ink passes. Here, the surface of the nozzle plate 530 facing in the Z2 direction is a nozzle surface FN. The nozzle plate 530 is manufactured, for example, through processing of a silicon single crystal substrate by a semiconductor manufacturing technique using a processing technique such as dry etching or wet etching. By providing the nozzles N in the silicon substrate in this manner, the nozzles N can be formed with high precision using a semiconductor process such as the Bosch process. However, other known methods and materials may be appropriately used for manufacturing the nozzle plate 530. The cross-sectional shape of each nozzle N is an irregular shape different from a circular shape. Details of the cross-sectional shape of the nozzle N will be described later with reference to FIGS. 4 and 5.

In the communication substrate 510, a flow path R1, a plurality of supply flow paths Ra, and a plurality of communication flow paths Na are provided for each of the first nozzle row In1 and the second nozzle row Ln2. The flow path R1 is a flow path provided in common to the plurality of nozzles N, is in communication with the plurality of nozzles N, is located upstream of the nozzles N, and is configured as an elongated hole that extends in the direction along the Y-axis in plan view viewed in the direction along the Z-axis. Each of the supply flow paths Ra and the communication flow paths Na is a flow path including a through-hole formed for each nozzle N. Each supply flow path Ra is in communication with the flow path R1.

The communication substrate 510 is manufactured, for example, through processing of a silicon single crystal substrate by a semiconductor manufacturing technique, similarly to the nozzle plate 530 described above. However, other known methods and materials may be appropriately used for manufacturing the communication substrate 510.

The pressure chamber substrate 520 is a plate-shaped member provided with a plurality of pressure chambers C1 called cavities for each of the first nozzle row In1 and the second nozzle row Ln2. The plurality of pressure chambers C1 is arranged in the direction along the Y-axis. Each pressure chamber C1 is an elongated space formed for each nozzle N and extending in a direction along the X-axis in plan view. The pressure chamber C1 is filled with the liquid to be ejected from the nozzle N.

The pressure chamber substrate 520 is manufactured, for example, through processing of a silicon single crystal substrate by a semiconductor manufacturing technique similarly to the nozzle plate 530 described above. However, other known methods and materials may be appropriately used for manufacturing the pressure chamber substrate 520.

The pressure chambers C1 are located between the communication substrate 510 and the vibration plate 550. The plurality of pressure chambers C1 is arranged in the direction along the Y-axis for each of the first nozzle row Ln1 and the second nozzle row Ln2. In addition, each of the pressure chambers C1 is in communication with a corresponding one of the communication flow paths Na and of the supply flow paths Ra. Therefore, each pressure chamber C1 is in communication with the nozzle N through the communication flow path Na and in communication with the flow path R1 through the supply flow path Ra.

The vibration plate 550 is disposed on the pressure chamber substrate 520, more specifically, on the surface of the pressure chamber substrate 520 facing in the Z1 direction. The vibration plate 550 is a plate-shaped member that is elastically vibratable and is vibrated by the piezoelectric elements 560. Although not illustrated, for example, the vibration plate 550 includes an elastic film made of silicon oxide (SiO₂) and an insulating film made of zirconium oxide (ZrO₂), and these films are stacked in this order in the Z1 direction. The elastic film is formed, for example, by thermally oxidizing one surface of a silicon single crystal substrate. The insulating film is formed, for example, by forming a zirconium layer by a sputtering method and thermally oxidizing the layer. The vibration plate 550 is not limited to the above-described configuration in which the elastic film and the insulating film are stacked, and may be formed of, for example, a single layer or three or more layers.

On the surface of the vibration plate 550 facing in the Z1 direction, the plurality of piezoelectric elements 560 mutually corresponding to the nozzles N is disposed for each of the first nozzle row Ln1 and the second nozzle row Ln2. Each piezoelectric element 560 is a passive element that is deformed by supplying a potential corresponding to the drive signal Com, and causes pressure fluctuation in the ink in the pressure chamber C1. As described above, the piezoelectric element 560 is driven by the drive signal Com, and the volume of the pressure chamber C1 changes according to the driving of the piezoelectric element 560. Each piezoelectric element 560 has an elongated shape extending in the direction along the X-axis in plan view. The plurality of piezoelectric elements 560 is arranged in a direction along the Y-axis to correspond to the plurality of pressure chambers C1. The piezoelectric elements 560 overlap with the pressure chambers C1 in plan view. The above-described piezoelectric elements 560 apply pressure to the pressure chambers C1 in communication with the nozzles N that eject the ink.

Although not illustrated, each piezoelectric element 560 includes, for example, a first electrode, a piezoelectric body, and a second electrode, which are stacked in this order in the Z1 direction. One electrode of the first electrode and the second electrode is an individual electrode that is disposed to be separated from another one for each piezoelectric element 560, and the drive signal Com is supplied to the one electrode from the control module 20. The other electrode of the first electrode and the second electrode is a band-shaped common electrode extending in the direction along the Y-axis so as to be continuous over the plurality of piezoelectric elements 560, and for example, a constant potential is supplied to the other electrode. Examples of the metal material of these electrodes include metal materials such as platinum (Pt), aluminum (Al), nickel (Ni), gold (Au), and copper (Cu), and among these materials, one kind may be used alone, or two or more kinds may be used in combination in an alloyed or stacked manner. The piezoelectric body is made of a piezoelectric material such as lead zirconate titanate (Pb (Zr, Ti) O₃). The piezoelectric body may be integrally provided over the plurality of piezoelectric elements 560, or may be individually provided for each piezoelectric element 560.

The protective substrate 570 is a plate-shaped member installed on the surface of the vibration plate 550 facing in the Z1 direction, protects the plurality of piezoelectric elements 560, and reinforces the mechanical strength of the vibration plate 550. Here, the plurality of piezoelectric elements 560 is accommodated in a space S between the protective substrate 570 and the vibration plate 550. For example, the protective substrate 570 is made of a resin material.

The case 580 is a case for storing the ink to be supplied to the plurality of pressure chambers C1. For example, the case 580 is made of a resin material. The case 580 is provided with a flow path R2 for each of the first nozzle row Ln1 and the second nozzle row Ln2. The flow path R2 is a space connected to the above-described flow path R1, and includes an elongated hole extending in the direction along the Y-axis in plan view viewed in the direction along the Z-axis. The flow path R2 is in communication with the nozzles N and functions as a reservoir R that stores the ink supplied to the plurality of pressure chambers C1, together with the flow path R1. The case 580 is provided with inlets HL for supplying the ink to each reservoir R. The ink in each reservoir R is supplied to the pressure chamber C1 through each supply flow path Ra. Note that aspects such as the positions and the number of the inlets HL for each reservoir R are not limited to the examples of FIGS. 2 and 3, and are appropriately selected.

Each vibration absorber 540 is also called a compliance substrate, is a flexible resin film forming a wall surface of the reservoir R, and absorbs the pressure fluctuation in the ink in the reservoir R. The vibration absorber 540 may be a flexible thin plate made of metal. The surface of the vibration absorber 540 facing in the Z1 direction is bonded to the communication substrate 510 with an adhesive or the like.

The wiring substrate 590 is a mounted component that is mounted on the surface of the vibration plate 550 facing in the Z1 direction, and electrically couples the control module 20 and the liquid ejecting head 50. For example, the wiring substrate 590 is a flexible wiring substrate such as a chip on film (COF), a flexible printed circuit (FPC), or a flexible flat cable (FFC). The drive circuit 600 is mounted on the wiring substrate 590 of the present embodiment. The drive circuit 600 switches whether or not to supply a pulse included in the drive signal Com output from the control module 20 to each of the plurality of piezoelectric elements 560 of the liquid ejecting head 50 under the control of the control module 20. As described above, the wiring substrate 590 supplies the drive signal Com for driving the piezoelectric element 560. The wiring substrate 590 may be a rigid substrate. In this case, the drive circuit 600 is mounted on the rigid substrate or a flexible substrate connected to the rigid substrate.

### 1-3: Nozzle

FIG. 4 is a sectional view of the nozzle N in the first embodiment. FIG. 5 is a plan view of the nozzle N in the first embodiment. As illustrated in FIGS. 4 and 5, the nozzle N includes a first nozzle portion N1 and a second nozzle portion N2. The second nozzle portion N2 and the first nozzle portion N1 are arranged in this order in the ejecting direction DN. In the illustrated example, the first nozzle portion N1 and the second nozzle portion N2 are adjacent to each other. FIG. 5 is a view of the nozzle N viewed in a direction opposite to the ejecting direction DN. In FIG. 5, the outer shape of the end of the nozzle N in the ejecting direction DN is indicated by a solid line, and the outer shape of the end of the nozzle N in the direction opposite to the ejecting direction DN is indicated by a broken line.

The first nozzle portion N1 is a hole having an opening OP that is open to the nozzle surface FN of the nozzle plate 530. The first nozzle portion N1 is defined by a side surface NS1 along the ejecting direction DN which is a direction in which the liquid is ejected from the first nozzle portion N1. The opening OP is an opening for ejecting the liquid. In the example illustrated in FIG. 5, the opening OP includes two ejection openings OPa and a communication portion OPb. Each of the ejection openings OPa has a shape along a circle when viewed in a direction along a central axis PC of the nozzle. The communication portion OPb connects the two ejection openings OPa. As a result, the two ejection openings OPa are in communication with each other with the communication portion OPb interposed therebetween. A width Wb of the communication portion OPb is narrower than a width Wa of each of a plurality of the ejection openings OPa. As a result, the capillary force of the communication portion OPb can be made higher than the capillary force of each ejection opening OPa. Therefore, the liquid droplets ejected from the plurality of ejection openings OPa are directed in directions approaching each other, and thus landing of the liquid droplets on the recording medium M in a split state can be suppressed.

The width Wa is the length of each ejection opening OPa in a direction orthogonal to the direction in which the two ejection openings OPa are arranged in plan view. The width Wb is the length of the communication portion OPb in the direction orthogonal to the direction in which the two ejection openings OPa are arranged.

Each of the plurality of ejection openings OPa has a shape along a circle when viewed in the direction along the central axis PC of the nozzle N. Therefore, the surface energy of the liquid in each ejection opening OPa can be stabilized, and thus the ejection of the liquid from the nozzle N can be stabilized.

As illustrated in FIG. 5, inner side surfaces SD-1 and SD-2 and protrusions PR-1 and PR-2 are provided on the side surface NS1 of the first nozzle portion N1. Hereinafter, when the inner side surfaces SD-1 and SD-2 are not distinguished from each other, each of the inner side surfaces SD-1 and SD-2 is referred to as an inner side surface SD. When the protrusions PR-1 and PR-2 are not distinguished from each other, each of the protrusions PR-1 and PR-2 is referred to as a protrusion PR.

The protrusions PR-1 and PR-2, which are a plurality of (a pair of, in the present embodiment) the protrusions PR, are portions protruding toward the central axis PC of the nozzle N with the inner side surface SD as a reference, and extend in the ejecting direction DN. In the illustrated example, each protrusion PR extends in the ejecting direction DN over the entire region of the first nozzle portion N1 in the ejecting direction DN. A space between the pair of protrusions PR defines the communication portion OPb.

The inner side surface SD is a portion of the side surface NS1. The inner side surface SD defines the ejection opening OPa.

The first nozzle portion N1 defined by the side surface NS1 is divided into a first region RE1 and a second region RE2 by the protrusions PR-1 and PR-2 in plan view. That is, when the first nozzle portion N1 is viewed in plan view, the first nozzle portion N1 is divided into the first region RE1 and the second region RE2 with the pair of protrusions PR interposed therebetween. Here, each of the first region RE1 and the second region RE2 has a shape along a circle. As described above, since each region divided by the protrusions PR has a circular shape, a portion of a liquid droplet ejected from each region on a side opposite to the protrusions PR has a stable shape, and a portion of the liquid droplet on the side where the protrusions PR are provided has an unstable shape. Therefore, since the liquid ejected from the respective regions is united on the protrusions PR side, the liquid droplet does not easily split.

A width W1, which is the inner diameter of the first nozzle portion N1, is constant over the entire region between the second nozzle portion N2 and the opening OP. That is, the width W1 of the first nozzle portion N1 is constant over the entire region of the first nozzle portion N1 in the ejecting direction DN. As a result, since an error in manufacturing the nozzle N is unlikely to occur, the ejection of the liquid from the nozzle N can be stabilized. In addition, a length L1 of the first nozzle portion N1 having the constant width W1 in the ejecting direction DN is shorter than a length L2 of the second nozzle portion N2 in the ejecting direction DN, and is preferably 4/9 of the length L2 or less, and more preferably ⅕ of the length L2 or less. The length L1 may be equal to or larger than the length L2, but is preferably 8/5 of the length L2 or less.

The second nozzle portion N2 is a hole located between the pressure chamber C1 and the first nozzle portion N1, is located upstream of the first nozzle portion N1 in the ejecting direction DN, and is connected to the first nozzle portion N1. A width W2 of the second nozzle portion N2 is larger than the width W1 of the first nozzle portion N1. As described above, since the second nozzle portion N2 is provided, the supply and replacement of the liquid to the first nozzle portion N1 are facilitated.

The second nozzle portion N2 has a tapered shape whose radius decreases toward the first nozzle portion N1. As a result, even when a large pull-strike waveform is applied to produce a high ejection amount, incorporation of bubbles in the nozzle N can be suppressed. The second nozzle portion N2 is defined by a side surface NS2 inclined with respect to the central axis PC of the nozzle N. The side surface NS2 constitutes an inclined portion SL1 that is inclined such that the inner diameter of the nozzle N decreases toward the opening OP. As described above, the second nozzle portion N2 has the inclined portion SL1. Therefore, dischargeability of bubbles in the nozzle N can be improved. As a result, bubbles remaining in the nozzle N can be suppressed.

As illustrated in FIG. 4, when viewed in a cross section including the central axis PC of the nozzle N, an angle θ formed by the central axis PC and the inclined portion SL1 is preferably 10° or more and 20° or less, and more preferably 12° or more and 18° or less. As a result, both dischargeability of the bubbles and the supply property of the liquid in the nozzles N can be achieved. On the other hand, when the angle θ is too large, the liquid discharge performance of the nozzle N tends to deteriorate depending on the type of the liquid or the like. On the other hand, when the angle θ is too small, the inertance in the nozzle N becomes too large depending on the type of the liquid or the like, and the supply property of the liquid to the nozzle N tends to deteriorate.

In plan view, the shape of the second nozzle portion N2 is similar to the shape of the first nozzle portion N1. That is, the shape of the first nozzle portion N1 and the shape of the second nozzle portion N2 are similar to each other when viewed in the direction along the central axis PC of the nozzle N. Therefore, the space in which bubbles remain at the boundary between the first nozzle portion N1 and the second nozzle portion N2 can be reduced. As a result, bubbles remaining in the second nozzle portion N2 can be suppressed.

The inclined portion SL1 does not have a scallop structure having protrusions and recesses. As a result, bubbles remaining in the nozzles N can be suitably suppressed. On the other hand, in an aspect in which a scallop structure is provided, since bubbles enter recesses of the scallop structure, the bubbles are likely to remain in the nozzle N.

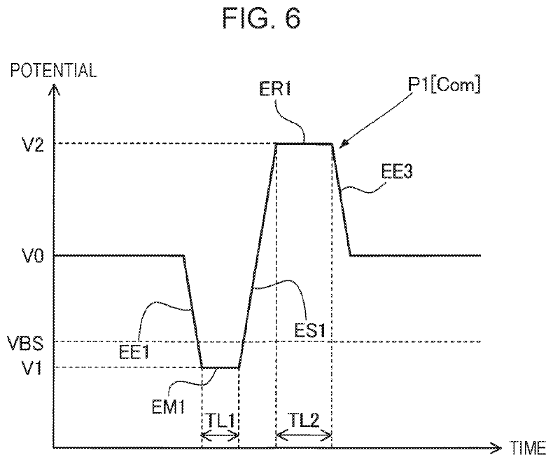

FIG. 6 is an explanatory diagram of an example of the drive signal Com. As illustrated in FIG. 6, the drive signal Com includes an ejection pulse P1.

The ejection pulse P1 is a pulse for ejecting ink as liquid droplets from the nozzle N. The ejection pulse P1 is supplied to the piezoelectric element 560 to cause pressure fluctuation in the ink in the pressure chamber C1 so that the ink is ejected from the nozzle N. In the example illustrated in FIG. 6, the ejection pulse P1 includes an expansion element EE1, an expansion maintenance element EM1, a contraction element ES1, a contraction maintenance element ER1, and a damping element EE3 in this order.

The expansion element EE1 is a potential element that changes in potential from an intermediate potential V0 to a potential V1 so as to decrease the pressure in the pressure chamber C1. That is, the expansion element EE1 is an element that expands the pressure chamber C1 and pulls the liquid from the first nozzle portion N1 to the pressure chamber C1 side. The expansion maintenance element EM1 is a potential element that is connected to the expansion element EE1 and maintains the potential V1 for a period TL1. The contraction element ES1 is a potential element that is connected to the expansion maintenance element EM1 and changes in potential from the potential V1 to a predetermined terminal potential so as to increase the pressure in the pressure chamber C1. The contraction maintenance element ER1 is a potential element that is located after the contraction element ES1 and maintains a potential V2 equal to or higher than the terminal potential of the contraction element ES1 for a period TL2. That is, the contraction element ES1 is an element that causes the liquid to be ejected from the first nozzle portion N1 by contracting the pressure chamber C1. The damping element EE3 is a potential element that changes in potential from the terminal end of the contraction maintenance element ER1 to the intermediate potential V0 so as to change in potential to reduce the pressure in the pressure chambers C1, and damps the pressure vibration generated in the pressure chamber C1 when the contraction maintenance element ER1 is supplied to the piezoelectric element 560.

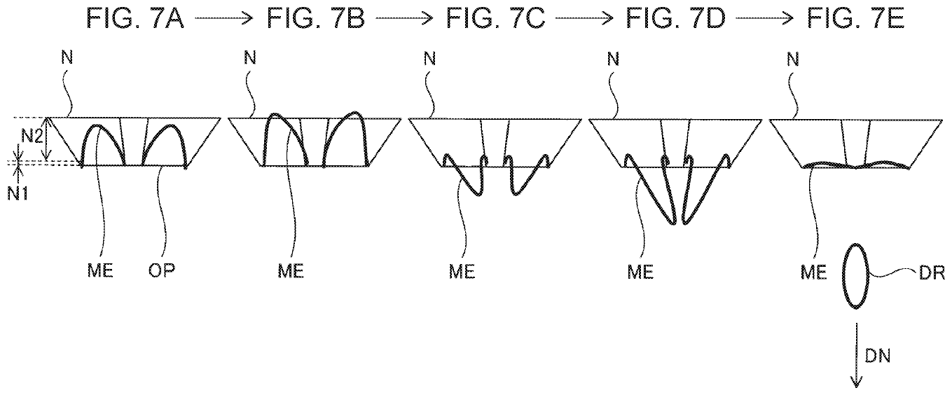

FIGS. 7A to 7E are explanatory diagrams of a meniscus ME when the drive signal Com illustrated in FIG. 6 is used. FIGS. 7A to 7E illustrate, in this order, changes over time of the meniscus ME when a liquid droplet is ejected from the nozzle N using the drive signal Com illustrated in FIG. 6.

When the drive signal Com having the waveform illustrated in FIG. 6 is used, the meniscus ME in the first nozzle portion N1 is pulled into the second nozzle portion N2 as illustrated in FIGS. 7A and 7B by expanding the pressure chamber C1 by the expansion element EE1. As described above, the expansion element EE1 expands the pressure chamber C1 so as to pull the liquid until the meniscus ME formed in the nozzle N is located in the second nozzle portion N2. In addition, as illustrated in FIGS. 7C and 7D, the meniscus ME is deformed toward the opening OP by contracting the pressure chamber C1 by the contraction element ES1, and then, as illustrated in FIG. 7E, a liquid droplet DR is ejected from the opening OP.

In this manner, after the liquid is pulled from the first nozzle portion N1 to the pressure chamber C1 side by expanding the pressure chamber C1, the liquid can be ejected from the first nozzle portion N1 by contracting the pressure chamber C1. Here, since the second nozzle portion N2 has the inclined portion SL1 as described above, bubbles remaining in the second nozzle portion N2 can be suppressed even when the bubbles are pulled into the second nozzle portion N2 when the liquid is pulled from the first nozzle portion N1 to the pressure chamber C1 side. In addition, even when liquid droplets split for each ejection opening OPa are generated, the liquid droplets are ejected in directions approaching each other by the inclined portion SL1, and can be united before landing on the recording medium M.

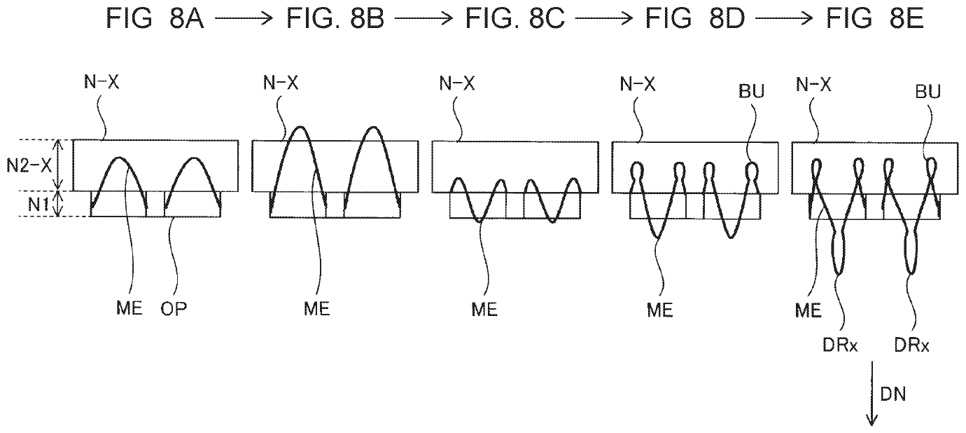

FIGS. 8A to 8E are explanatory diagrams of the meniscus ME of a nozzle N-X without the inclined portion SL1. FIGS. 8A to 8E illustrate, in this order, changes over time in the meniscus ME when liquid droplets are ejected from the nozzle N-X using the drive signal Com illustrated in FIG. 6. The nozzle N-X is configured in the same manner as the nozzle N except that the nozzle N-X includes a second nozzle portion N2-X instead of the second nozzle portion N2. The second nozzle portion N2-X is configured in the same manner as the second nozzle portion N2 except that the second nozzle portion N2-X has a circular shape in plan view and has a constant width over the length L2.

In the nozzle N-X, after the meniscus ME in the first nozzle portion N1 is pulled into the second nozzle portion N2-X by the expansion element EE1 as illustrated in FIGS. 8A and 8B, if the meniscus ME is deformed toward the opening OP by the contraction element ES1 as illustrated in FIGS. 8C and 8D, bubbles BU caught in the second nozzle portion N2-X remain in the second nozzle portion N2-X. This is because the space rapidly narrows from the second nozzle portion N2-X toward the first nozzle portion N1. In addition, such a phenomenon of incorporating the bubbles BU becomes more remarkable as the ejection speed of the liquid droplet increases, because the bubbles BU are less likely to follow the displacement of the meniscus ME.

Such bubbles BU are generated in each ejection opening OPa. Therefore, not only liquid droplets DRx split for each ejection opening OPa are easily generated, but also the liquid droplets DRx are easily ejected in a direction away from each other. Therefore, as illustrated in FIG. 8E, the split liquid droplets DRx are ejected.

On the other hand, as described above, in the liquid ejecting head 50, the inclined portion SL1, which is inclined such that the inner diameter of the nozzle N decreases toward the opening OP, is provided on the side surface NS2 of the nozzle N, and thus dischargeability of bubbles in the nozzle N can be improved. As a result, bubbles remaining in the nozzle N can be suppressed.

### 2. Second Embodiment

Hereinafter, a second embodiment of the present disclosure will be described. In the embodiment to be described below, elements having the same effects and functions as those of the first embodiment will be denoted by the reference numerals used in the description of the first embodiment, and each of the elements will not be described in detail, as appropriate.

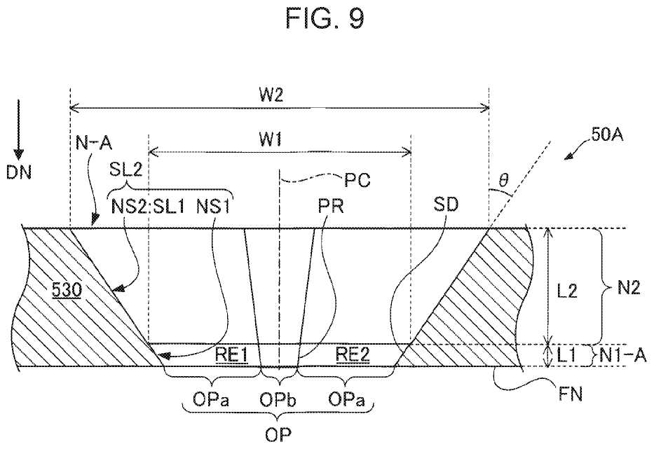

FIG. 9 is a sectional view of a nozzle N-A in the second embodiment. A liquid ejecting head 50A of the present embodiment is configured in the same manner as the liquid ejecting head 50 of the first embodiment except that the nozzle N-A is provided instead of the nozzle N of the first embodiment. The nozzle N-A is configured in the same manner as the nozzle N of the first embodiment except that a first nozzle portion N1-A is provided instead of the first nozzle portion N1 of the first embodiment. The first nozzle portion N1-A is configured in the same manner as the first nozzle portion N1 of the first embodiment except that the side surface NS1 is inclined with respect to the central axis PC.

The side surface NS1 of the first nozzle portion N1-A is inclined such that the inner diameter of the first nozzle portion N1 decreases toward the opening OP. As described above, the first nozzle portion N1-A has a shape in which the inner diameter of the first nozzle portion N1-A decreases toward the opening OP. As a result, the liquid droplets ejected from the plurality of ejection openings OPa are directed in directions approaching each other, and thus landing of the liquid droplets on the recording medium M in a split state can be suppressed.

In the illustrated example, the inclination angle of the side surface NS1 of the first nozzle portion N1-A with respect to the central axis PC is equal to the inclination angle θ of the side surface NS2 of the second nozzle portion N2 with respect to the central axis PC. Therefore, it can be said that the nozzle N-A is equivalent to a configuration in which the first nozzle portion N1 is omitted in the nozzle N of the first embodiment. That is, the nozzle N-A does not have to be divided into the first nozzle portion N1-A and the second nozzle portion N2. Here, the nozzle N-A has an inclined portion SL2 constituted by the side surface NS1 and the side surface NS2.

The inclination angle of the side surface NS1 of the first nozzle portion N1-A with respect to the central axis PC may be larger or smaller than the angle θ, but is preferably 10° or more and 20° or less, and more preferably 12° or more and 18° or less. As a result, both the dischargeability of bubbles and the supply property of the liquid in the nozzle N can be suitably achieved.

The length L1 of the first nozzle portion N1-A in the ejecting direction DN is shorter than the length L2 of the second nozzle portion N2 in the ejecting direction DN, and is preferably 4/9 or less of the length L2, and more preferably ⅕ or less of the length L2. The length L1 may be equal to or larger than the length L2, but is preferably 8/5 of the length L2 or less.

According to the second embodiment described above, bubbles remaining in the nozzle N-A can be suppressed.

### 3. Third Embodiment

Hereinafter, a third embodiment of the present disclosure will be described. In the embodiment to be described below, elements having the same effects and functions as those of the first embodiment will be denoted by the reference numerals used in the description of the first embodiment, and each of the elements will not be described in detail, as appropriate.

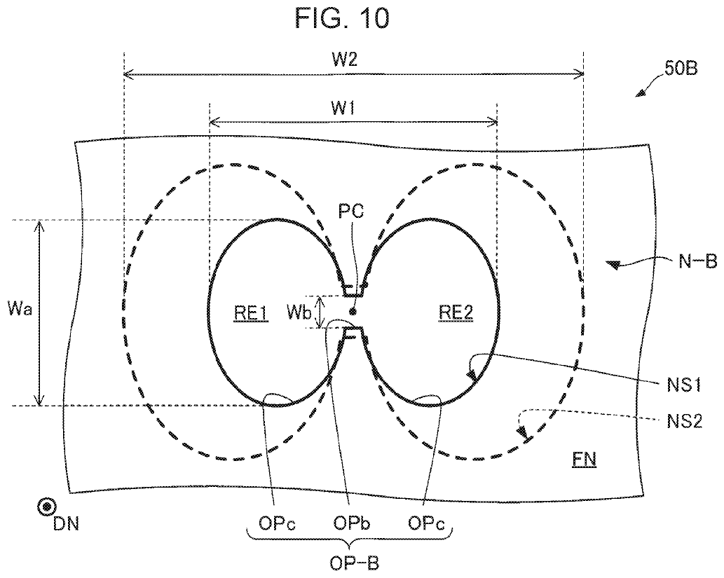

FIG. 10 is a plan view of a nozzle N-B in the third embodiment. A liquid ejecting head 50B of the present embodiment is configured in the same manner as the liquid ejecting head 50 of the first embodiment except that the nozzle N-B is provided instead of the nozzle N of the first embodiment. The nozzle N-B includes an opening OP-B instead of the opening OP of the first embodiment, and is configured in the same manner as the nozzle N of the first embodiment except that the shape in plan view is different.

The opening OP-B is the same as the opening OP of the first embodiment except that the opening OP-B includes two ejection openings OPc instead of the two ejection openings OPa of the first embodiment.

Each of the two ejection openings OPc has a shape along an oval shape when viewed in the direction along the central axis PC of the nozzle N. As a result, the capillary force of the liquid in the opening OP can be increased compared to the aspect in which the cross-sectional shape of each ejection opening OPa is a circular shape as in the first embodiment. As a result, the meniscus in the nozzle N can be stabilized.

In the illustrated example, a direction orthogonal to a direction in which the two ejection openings OPc are arranged in plan view is defined as a major axis direction of each of the ejection openings OPc.

According to the third embodiment described above, bubbles remaining in the nozzle N-B can be suppressed.

### 4. Modifications

Each of the above-described embodiments can be variously modified. Specific modification aspects that can be applied to each of the above-described embodiments will be described below. The aspects selected in any manner from the following examples can be appropriately combined with each other within a range of not being inconsistent with each other.

### 4-1: First Modification

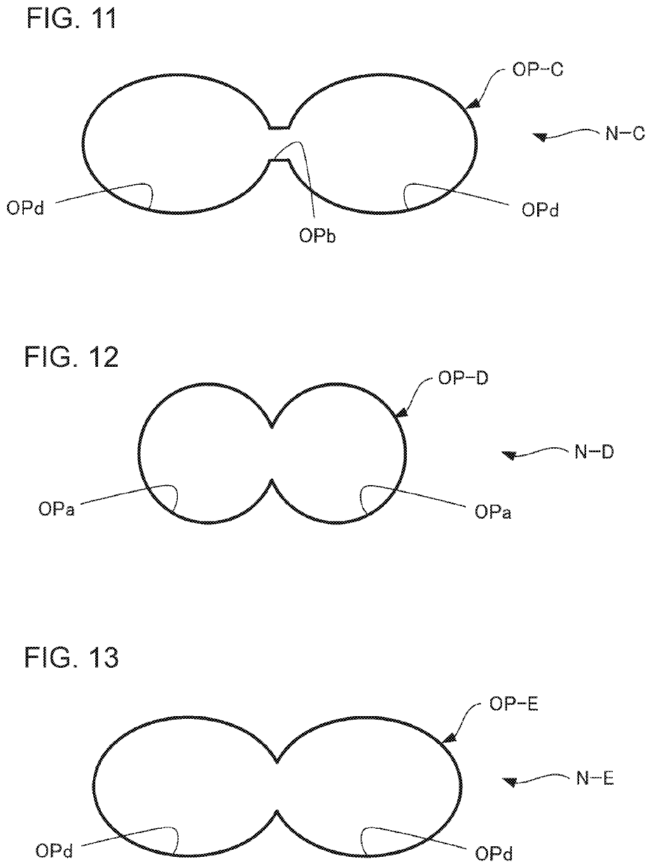

FIG. 11 is a plan view of an opening OP-C of a nozzle N-C according to a first modification. The nozzle N-C includes the opening OP-C instead of the opening OP of the first embodiment, and is configured in the same manner as the nozzle N of the first embodiment except that the shape in plan view is different.

The opening OP-C is the same as the opening OP of the first embodiment except that the opening OP-C includes two ejection openings OPd instead of the two ejection openings OPa of the first embodiment.

Each of the two ejection openings OPd has a shape along an oval shape when viewed in the direction along the central axis PC of the nozzle N. In the illustrated example, a direction in which the two ejection openings OPd are arranged in plan view is defined as a major axis direction of each of the ejection openings OPd.

According to the first modification described above, bubbles remaining in the nozzle N-C can be suppressed.

### 4-2: Second Modification

FIG. 12 is a plan view of an opening OP-D of a nozzle N-D of a second modification. The nozzle N-D includes the opening OP-D instead of the opening OP of the first embodiment, and is configured in the same manner as the nozzle N of the first embodiment except that the shape in plan view is different.

The opening OP-D is the same as the opening OP of the first embodiment except that the communication portion OPb of the first embodiment is omitted and the two ejection openings OPa are in communication with each other without the communication portion OPb interposed therebetween.

According to the second modification described above, bubbles remaining in the nozzle N-C can be suppressed.

### 4-3: Third Modification

FIG. 13 is a plan view of an opening OP-E of a nozzle N-E according to a third modification. The nozzle N-E includes the opening OP-E instead of the opening OP of the first embodiment, and is configured in the same manner as the nozzle N of the first embodiment except that the shape in plan view is different.

The opening OP-E is the same as the opening OP-C of the first modification except that the communication portion OPb of the first modification is omitted and the two ejection openings OPd are in communication with each other without the communication portion OPb interposed therebetween.

According to the third modification described above, bubbles remaining in the nozzle N-E can be suppressed.

### 4-4: Fourth Modification

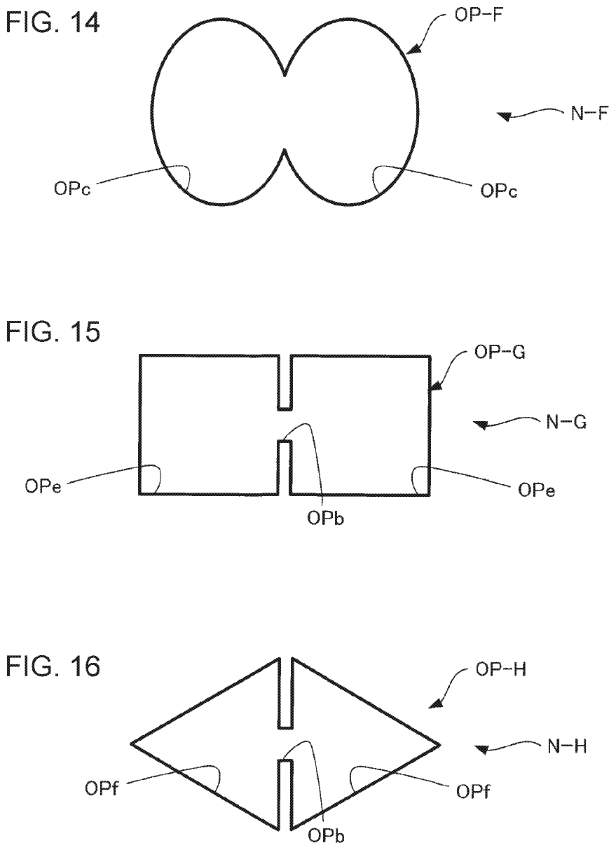

FIG. 14 is a plan view of an opening OP-F of a nozzle N-F of a fourth modification. The nozzle N-F includes the opening OP-F instead of the opening OP of the first embodiment, and is configured in the same manner as the nozzle N of the first embodiment except that the shape in plan view is different.

The opening OP-F is the same as the opening OP-B of the third embodiment except that the communication portion OPb of the third embodiment is omitted and the two ejection openings OPc are in communication with each other without the communication portion OPb interposed therebetween.

According to the fourth modification described above, bubbles remaining in the nozzle N-F can be suppressed.

### 4-5: Fifth Modification

FIG. 15 is a plan view of an opening OP-G of a nozzle N-G of a fifth modification. The nozzle N-G includes the opening OP-G instead of the opening OP of the first embodiment, and is configured in the same manner as the nozzle N of the first embodiment except that the shape in plan view is different.

The opening OP-G is the same as the opening OP of the first embodiment except that the opening OP-G includes two ejection openings OPe instead of the two ejection openings OPa of the first embodiment.

Each of the two ejection openings OPe has a shape along a quadrangle when viewed in the direction along the central axis PC of the nozzle N. In the illustrated example, each of the ejection openings OPe has a pair of sides along a direction in which the two ejection openings OPe are arranged and a pair of sides along a direction orthogonal to the direction in plan view. Each of the ejection openings OPe may be arranged so that each side is inclined with respect to the direction in which the two ejection openings OPe are arranged.

According to the fifth modification described above, bubbles remaining in the nozzle N-G can be suppressed.

### 4-6: Sixth Modification

FIG. 16 is a plan view of an opening OP-H of a nozzle N-H of a sixth modification. The nozzle N-H includes the opening OP-H instead of the opening OP of the first embodiment, and is configured in the same manner as the nozzle N of the first embodiment except that the shape in plan view is different.

The opening OP-H is the same as the opening OP of the first embodiment except that the opening OP-H includes two ejection openings OPf instead of the two ejection openings OPa of the first embodiment.

Each of the two ejection openings OPf has a shape along a triangle when viewed in the direction along the central axis PC of the nozzle N. In the illustrated example, the ejection openings OPf are arranged such that the sides of two ejection openings OPf are parallel to each other in plan view.

According to the sixth modification described above, bubbles remaining in the nozzle N-H can be suppressed.

### 4-7: Seventh Modification

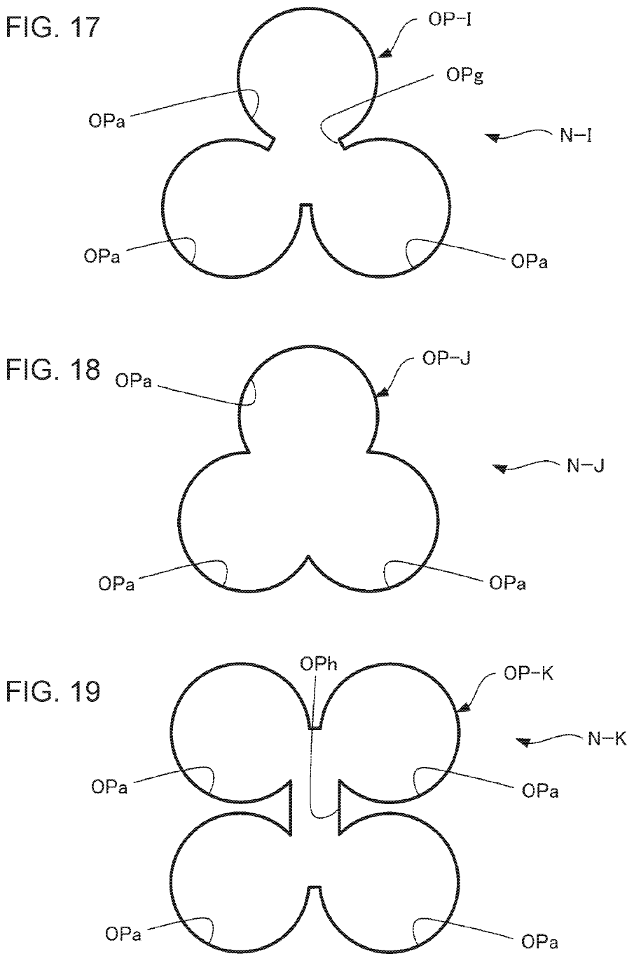

FIG. 17 is a plan view of an opening OP-I of a nozzle N-I of a seventh modification. The nozzle N-I includes the opening OP-I instead of the opening OP of the first embodiment, and is configured in the same manner as the nozzle N of the first embodiment except that the shape in plan view is different.

The opening OP-I is the same as the opening OP of the first embodiment except that the number of the ejection openings OPa of the first embodiment is three and a communication portion OPg is included instead of the communication portion OPb.

The three ejection openings OPa are arranged so as to be located at the apexes of an equilateral triangle. The communication portion OPg connects the three ejection openings OPa.

According to the seventh modification described above, bubbles remaining in the nozzle N-I can be suppressed.

### 4-8: Eighth Modification

FIG. 18 is a plan view of an opening OP-J of a nozzle N-J of an eighth modification. The nozzle N-J includes the opening OP-J instead of the opening OP of the first embodiment, and is configured in the same manner as the nozzle N of the first embodiment except that the shape in plan view is different.

The opening OP-J is the same as the opening OP-I of the seventh modification except that the communication portion OPg of the seventh modification is omitted and the three ejection openings OPa are in communication with each other without the communication portion OPg interposed therebetween.

According to the eighth modification described above, bubbles remaining in the nozzle N-J can be suppressed.

### 4-9: Ninth Modification

FIG. 19 is a plan view of an opening OP-K of a nozzle N-K of a ninth modification. The nozzle N-K includes the opening OP-K instead of the opening OP of the first embodiment, and is configured in the same manner as the nozzle N of the first embodiment except that the shape in plan view is different.

The opening OP-K is the same as the opening OP of the first embodiment except that the number of the ejection openings OPa of the first embodiment is four and a communication portion OPh is included instead of the communication portion OPb.

The four ejection openings OPa are arranged so as to be located at the apexes of a square. The communication portion OPh connects the four ejection openings OPa.

According to the ninth modification described above, bubbles remaining in the nozzle N-K can be suppressed.

### 4-10: Tenth Modification

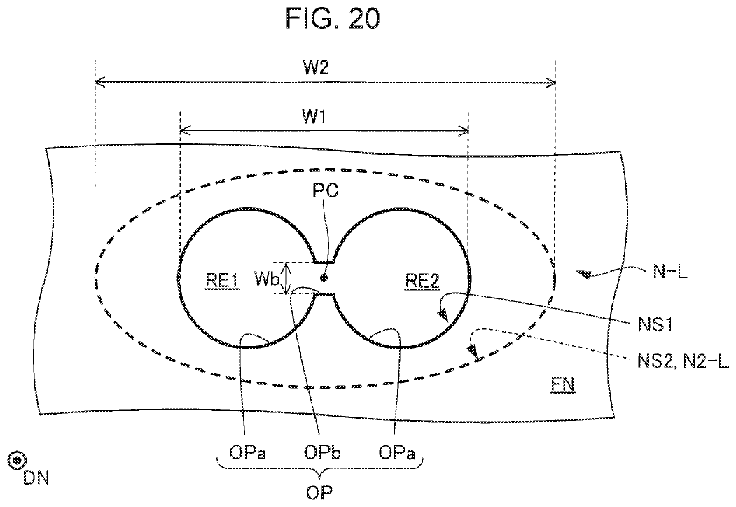

FIG. 20 is a plan view of a nozzle N-L according to a tenth modification. The nozzle N-L is configured in the same manner as the nozzle N of the first embodiment except that a second nozzle portion N2-L is provided instead of the second nozzle portion N2 of the first embodiment.

The second nozzle portion N2-L has a shape along an oval shape when viewed in the direction along the central axis PC of the nozzle N. In the illustrated example, in the second nozzle portion N2-L, a direction in which the two ejection openings OPa are arranged in plan view is a major axis direction. As described above, in the tenth modification, the shape of the second nozzle portion N2-L in plan view is not similar to the shape of the first nozzle portion N1 in plan view.

According to the tenth modification described above, bubbles remaining in the nozzle N-L can be suppressed.

### 4-11: Eleventh Modification

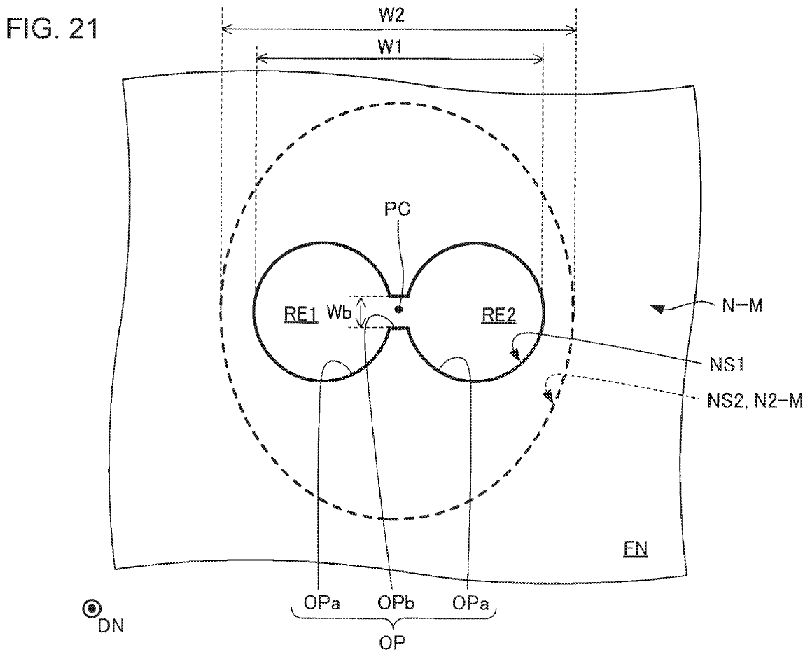

FIG. 21 is a plan view of a nozzle N-M of an eleventh modification. The nozzle N-M is configured in the same manner as the nozzle N of the first embodiment except that a second nozzle portion N2-M is provided instead of the second nozzle portion N2 of the first embodiment.

The second nozzle portion N2-M has a shape along an oval shape when viewed in the direction along the central axis PC of the nozzle N. In the illustrated example, in the second nozzle portion N2-M, a direction orthogonal to a direction in which the two ejection openings OPa are arranged in plan view is a major axis direction. As described above, in the eleventh modification, the shape of the second nozzle portion N2-M in plan view is not similar to the shape of the first nozzle portion N1 in plan view.

According to the eleventh modification described above, bubbles remaining in the nozzle N-M can be suppressed.

### 4-12: Twelfth Modification

The inclined portion SL1 may have a scallop structure having protrusions and recesses.

### 4-13: Thirteenth Modification

In each of the above-described embodiments, the printing apparatus 100 of a serial type that reciprocates the carriage 41, on which the liquid ejecting heads 50 are mounted, is exemplified, but the present disclosure is also applied to a printing apparatus of a line type in which the plurality of nozzles N is distributed over the entire width of the recording medium M.

### 4-14: Fourteenth Modification

The printing apparatus 100 exemplified in the above-described embodiments may be employed in various apparatuses such as a facsimile apparatus and a copy machine in addition to an apparatus dedicated to printing, and the application of the present disclosure is not particularly limited. However, the use of the printing apparatus is not limited to printing. For example, a printing apparatus that ejects a solution of a coloring material is used as a manufacturing apparatus that forms a color filter of a display device such as a liquid crystal display panel. In addition, a printing apparatus that ejects a solution of a conductive material is used as a manufacturing apparatus that forms wiring and electrodes of a wiring substrate. A printing apparatus that ejects a solution of an organic substance relating to a living body is used as, for example, a manufacturing apparatus for manufacturing a biochip.

What is claimed is:

1. A liquid ejecting head comprising:
a nozzle that ejects a liquid, wherein
the nozzle includes
an opening that includes a plurality of ejection openings in communication with each other and ejects the liquid, and
an inclined portion provided on a side surface of the nozzle and inclined such that an inner diameter of the nozzle decreases toward the opening.

2. The liquid ejecting head according to claim 1, wherein
the inclined portion does not have a scallop structure having protrusions and recess.

3. The liquid ejecting head according to claim 1, wherein
when viewed in a cross section including a central axis of the nozzle, the central axis and the inclined portion form an angle of 10° or more and 20° or less.

4. The liquid ejecting head according to claim 1, wherein
each of the plurality of ejection openings has a shape along a circle when viewed in a direction along a central axis of the nozzle.

5. The liquid ejecting head according to claim 1, wherein
the plurality of ejection openings is two ejection openings, and
each of the plurality of ejection openings has a shape along an oval shape when viewed in a direction along a central axis of the nozzle.

6. The liquid ejecting head according to claim 1, wherein
the opening includes a communication portion connecting the plurality of ejection openings, and
the communication portion has a width narrower than a width of each of the plurality of ejection openings.

7. The liquid ejecting head according to claim 1, wherein
the nozzle includes
a first nozzle portion including the opening, and
a second nozzle portion including the inclined portion, located upstream of the first nozzle portion in an ejecting direction that is a direction in which the liquid is ejected from the nozzle, and connected to the first nozzle portion, and
the first nozzle portion has an inner diameter constant over an entire region between the second nozzle portion and the opening.

8. The liquid ejecting head according to claim 1, wherein
the nozzle includes
a first nozzle portion including the opening, and
a second nozzle portion including the inclined portion, located upstream of the first nozzle portion in an ejecting direction that is a direction in which the liquid is ejected from the nozzle, and connected to the first nozzle portion, and
the first nozzle portion has a shape in which an inner diameter of the first nozzle portion decreases toward the opening.

9. The liquid ejecting head according to claim 1, wherein
the nozzle includes
a first nozzle portion including the opening, and
a second nozzle portion including the inclined portion, located upstream of the first nozzle portion in an ejecting direction that is a direction in which the liquid is ejected from the nozzle, and connected to the first nozzle portion, and
the first nozzle portion has a shape similar to a shape of the second nozzle portion when viewed in a direction along a central axis of the nozzle.

10. The liquid ejecting head according to claim 1, wherein
the nozzle is provided in a silicon substrate.

11. The liquid ejecting head according to claim 1, further comprising:
an actuator driven by a drive signal; and
a pressure chamber that is filled with the liquid ejected from the nozzle and of which a volume changes according to driving of the actuator, wherein
the nozzle includes
a first nozzle portion including the opening, and
a second nozzle portion including the inclined portion, located upstream of the first nozzle portion in an ejecting direction that is a direction in which the liquid is ejected from the nozzle, and connected to the first nozzle portion, and
the drive signal includes
an expansion element that expands the pressure chamber to pull the liquid from the first nozzle portion to the pressure chamber side, and
a contraction element that contracts the pressure chamber to cause the liquid to be ejected from the first nozzle portion.

12. The liquid ejecting head according to claim 11, wherein
the expansion element expands the pressure chamber to pull the liquid until a meniscus formed in the nozzle is located in the second nozzle portion.

13. A printing apparatus comprising:
the liquid ejecting head according to claim 1; and
a controller that controls an operation of the liquid ejecting head.
